(19) United States
(12) Patent Application Publication
(10) Pub. No.: US 2016/0240947 A1
(43) Pub. Date: Aug. 18, 2016

(54) CONNECTOR AND MANUFACTURING METHOD FOR CONNECTOR

(71) Applicants: HONG FU JIN PRECISION INDUSTRY (Wuhan) CO., LTD., Wuhan (CN); HON HAI PRECISION INDUSTRY CO., LTD., New Taipei (TW)

(72) Inventors: ZHI-MING ZHU, Wuhan (CN); TING WANG, Wuhan (CN)

(21) Appl. No.: 14/682,932

(22) Filed: Apr. 9, 2015

(30) Foreign Application Priority Data
Feb. 12, 2015 (CN) 201510073010.2

(51) Int. Cl. H01R 12/72; H01R 43/20

(52) U.S. Cl. CPC H01R 12/721; H01R 43/205

(57) ABSTRACT

A connector includes a securing tray, a circuit board, a plurality of pins attached to the securing tray, and a cable. Each pin includes a coupling terminal. The cable is coupled with the circuit board. The coupling terminals of the plurality of pins are located on a same plane and are coupled with the circuit board, and the plurality of pins is coupled with the cable via the circuit board. The disclosure further provides a manufacturing method for the connector.

### FIELD

The subject matter herein generally relates to a connector and a manufacturing method for the connector.

### BACKGROUND

Connectors are widely used in electronic devices, such computers, routers or servers to transmit power or signals between different electronic components. For different peripheral devices, the computers or servers often need different connectors, such as Universal Serial Bus (USB) connector for an input/output module, or a cable connector for supplying power for a router.

### BRIEF DESCRIPTION OF THE DRAWINGS

Implementations of the present technology will now be described, by way of example only, with reference to the attached figures.

FIG. 1 is an exploded, isometric view of a connector.

FIG. 2 is an exploded, isometric view of a main body of the connector of FIG. 1.

FIG. 3 is an exploded, isometric view of a securing tray and a plurality of pins of the main body of FIG. 2.

FIG. 4 is an isometric view of the plurality of pins of the main body of FIG. 3.

FIG. 5 is a side view of the plurality of pins of FIG. 4.

FIG. 6 is an assembled view of the connector of FIG. 1, without a protecting member.

FIG. 7 is an assembled view of the connector of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is described in relation to a connector. The connector includes a securing tray, a circuit board, a plurality of pins attached to the securing tray, and a cable. Each pin includes a coupling terminal. The cable is coupled with the circuit board. The coupling terminals of the plurality of pins are located on a same plane and are coupled with the circuit board, and the plurality of pins is coupled with the cable via the circuit board. The disclosure further provides a manufacturing method for the connector.

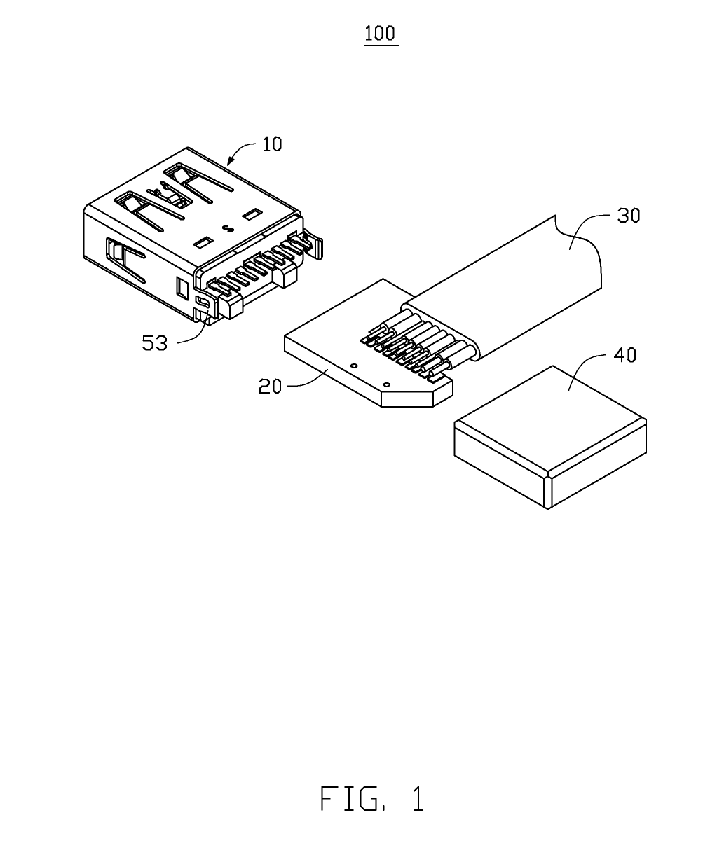

FIG. 1 illustrates an embodiment of a connector 100. The connector 100 can include a main body 10, a circuit board 20, a cable 30 electronically connected to the circuit board 20, and a protecting member 40 can be covering the circuit board 20 and the cable 30. In at least one embodiment, the connector 100 is a Universal Serial Bus (USB) 3.0 connector that can be used in an input/output module (not shown), and the cable 30 can be connected to the circuit board 20 by soldering.

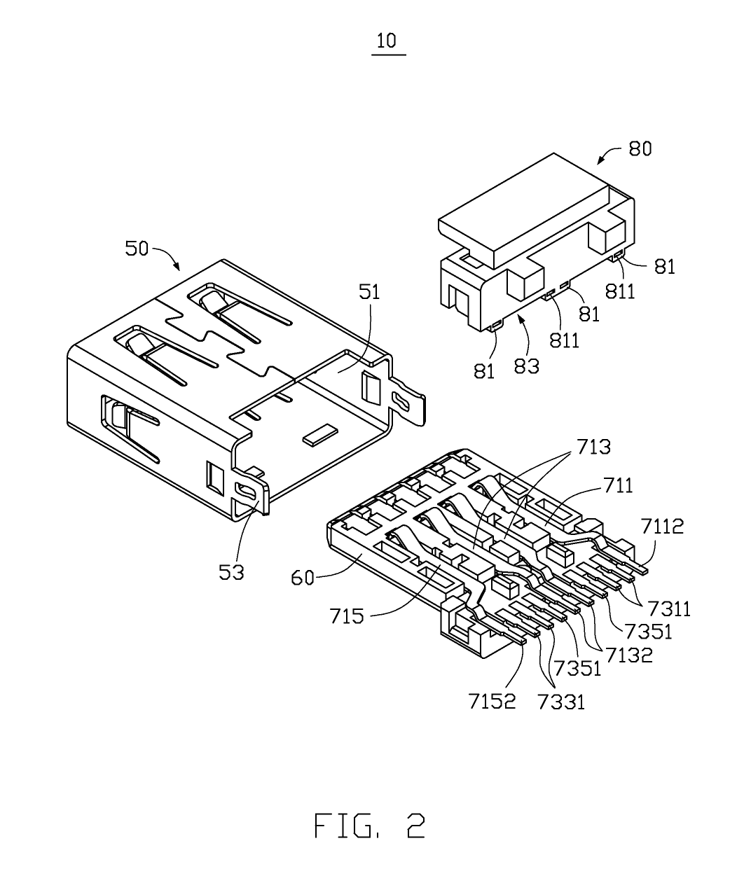

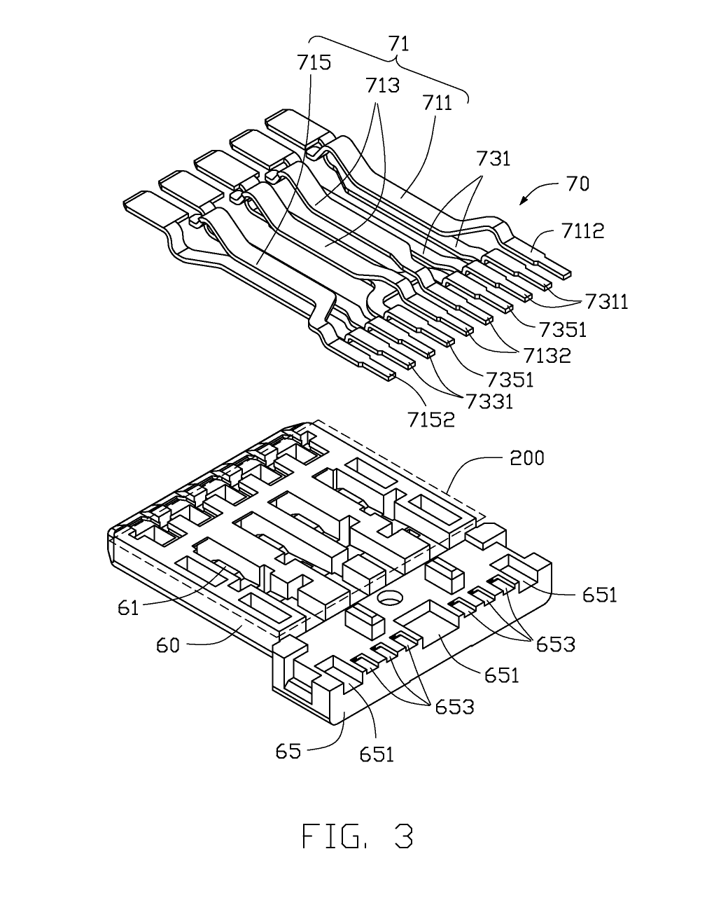

FIG. 2 illustrates an embodiment of the main body 10 of the connector 100. The main body 10 can include a receiving tray 50, a securing tray 60, a plurality of pins 70 (see FIG. 3) secured to the securing tray 60, and a positioning member 80 used to position the plurality of pins 70. The receiving tray 50 defines a receiving space 51 that is configured to receive the securing tray 60. Two clipping pieces 53 are located on a front portion of the receiving tray 50.

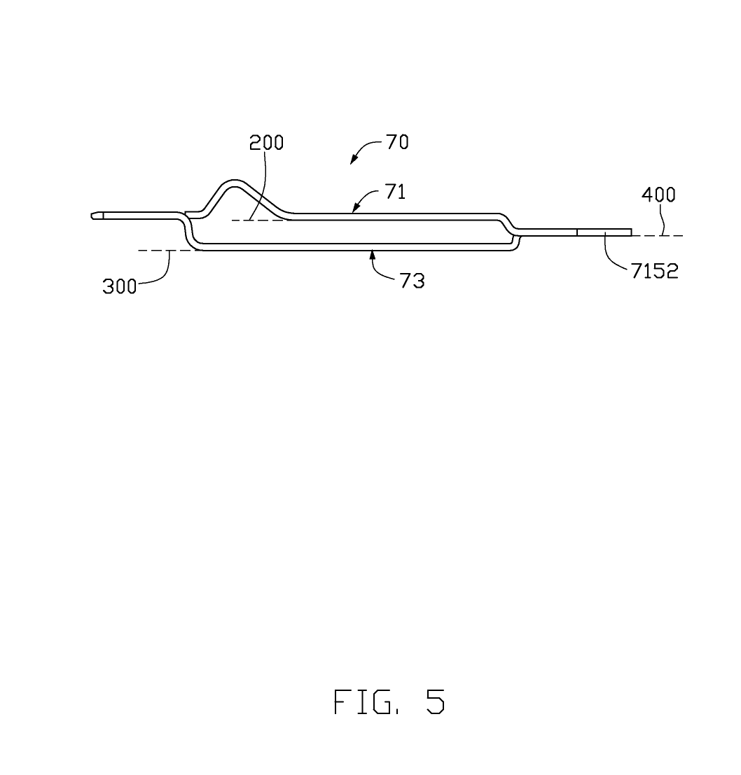

FIG. 3 illustrates an embodiment of the securing tray 60 and the plurality of pins 70. The securing tray 60 defines four first passages 61 and five second passages (not shown) opposite to the four first passages 61. The four first passages 61 are substantially parallel to each other and located on a first plane 200. The five second passages are substantially parallel to each other and located on a second plane 300 (see FIG. 5) that is substantially parallel to the first plane 200. The securing tray 60 can include a securing portion 65 that is configured to engage with the positioning member 80. Three receiving slots 651 and six clipping slots 653 are defined in the securing portion 65. Three clipping slots 653 are arranged at a row that is located between every two adjacent receiving slots 651.

FIG. 2 illustrates an embodiment of the positioning member 80. The positioning member 80 can include three positioning blocks 81. Each positioning block 81 can define at least one through hole 811. A port 83 is defined between every two adjacent positioning blocks 81.

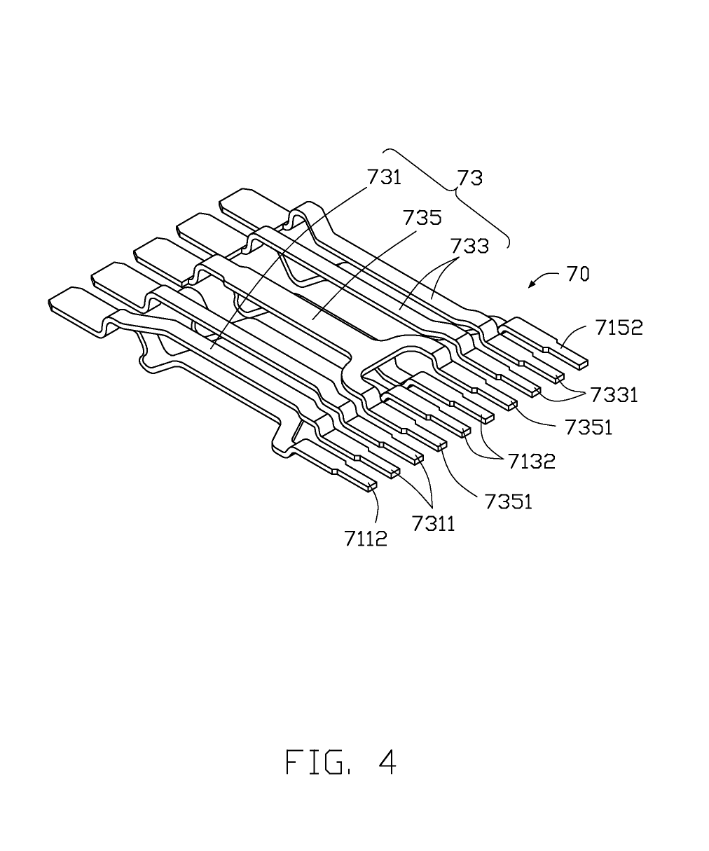

FIGS. 3-5 illustrate an embodiment of the plurality of pins 70. The plurality of pins 70 can include a first pin assembly 71 and a second pin assembly 73. Each pin of the first fin assembly 71 can be received in each first passage 61. In at least one embodiment, the first pin assembly 71 can include a power pin 711, two data pins 713, and a first ground pin 715. Each pin of the first fin assembly 71, such as the power pin 711, each data pin 713, and the first ground pin 715 can include a coupling terminal 7112, 7132, 7152. The coupling terminals 7112, 7132, 7152 can extend through the through holes 811.

Each pin of the second pin assembly 73 can be received in each second passage. In at least one embodiment, the second pin assembly 73 can include two super signal receiving pins 731, two super signal sending pins 733, and a second ground pin 735 located between the two signal receiving pins 731 and the two super signal sending pins 733. Each pin of the second fin assembly 73, such as each super signal receiving pins 731, each super signal sending pins 733 and the second ground pin 735 can include a coupling terminal 7311, 7331, 7351. The coupling terminals 7311, 7331, 7351 can extend through the clipping slots 653.

Each pin of the first pin assembly 71 can be located on the first plane 200, and each pin of the second pin assembly 73 can be located on the second plane 300. Each coupling terminal 7112, 7132, 7152, 7311, 7331, 7351 can be bent to be located on a third plane 400. The third plane 400 is substantially parallel to the first plane 200 and the second plane 300.

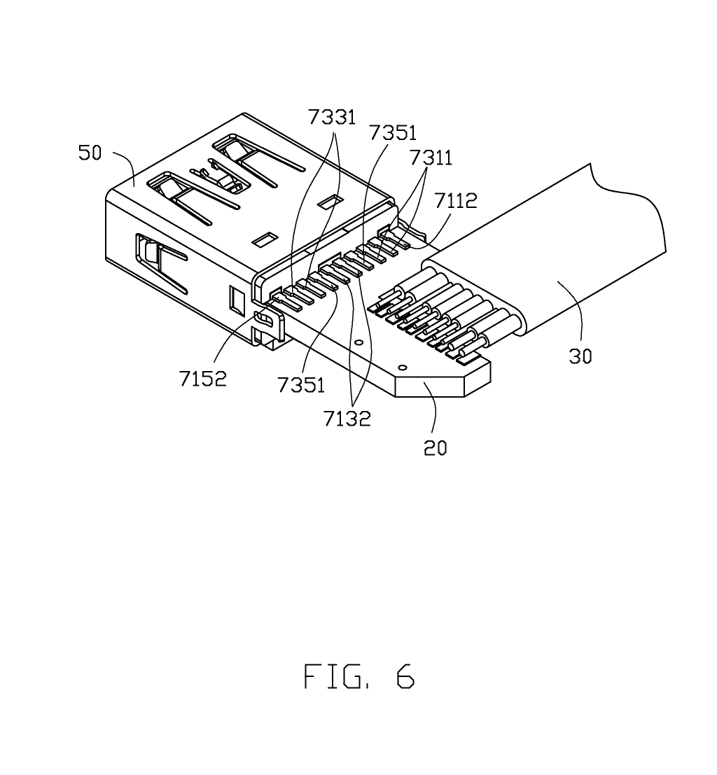

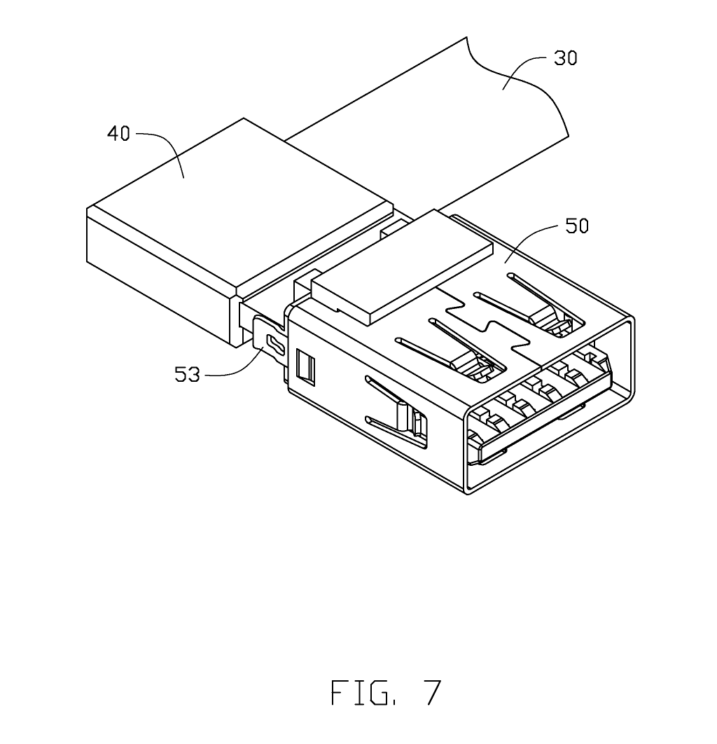

FIGS. 1 and 5-7 illustrate in assembly of the connector 100. Each pin of the first pin assembly 71 is located in each first passage 61, and each pin of the second pin assembly 73 is located in each second passage. Each coupling terminal 7112, 7132, 7152, 7311, 7331, 7351 is bent to be located on the third plane 400. The coupling terminal 7112 of the power pin 711 is located on a first side, and the coupling terminal 7152 of the first ground pin 715 is located on a second side opposite to the first side. The two coupling terminals of the data pins 713 are located between the coupling terminal 7112 and the coupling terminal 7152. The coupling terminals 7311 of the two super signal receiving pins 731 are located between the coupling terminal 7112 of the power pin 711 and one coupling terminal 7351 of the second ground pin 735. The coupling terminals 7331 of the two super signal sending pins 733 are located between the coupling pin 7152 of the first ground pin 715 and the another coupling terminal 7351 of the second ground pin 735.

The positioning member 80 is secured to the securing portion 65, so that each positioning block 81 is received in the receiving slot 651 and every three clipping slots 653 are received in each port 83. The coupling terminals 7112, 7132, 7152 extend through the through holes 811, and the coupling terminals 7311, 7331, 7351 extend through the clipping slots 653.

Each coupling terminal, such as the coupling terminals 7112, 7132, 7152, 7311, 7331, 7351 are coupled with the circuit board 20 by soldering. The cable 30 is coupled with the circuit board 20 by soldering. Therefore, the cable 30 can be coupled with the coupling terminals 7112, 7132, 7152, 7311, 7331, 7351. The protecting member 40 is attached to the circuit board 20 to protect the cable 30 and the coupling terminals 7112, 7132, 7152, 7311, 7331, 7351.

The embodiments shown and described above are only examples. Many details are often found in the art such as the other features of a connector. Therefore, many such details are neither shown nor described. Even though numerous characteristics and advantages of the present technology have been set forth in the foregoing description, together with details of the structure and function of the present disclosure, the disclosure is illustrative only, and changes can be made in the detail, especially in matters of shape, size and arrangement of the parts within the principles of the present disclosure up to, and including the full extent established by the broad general meaning of the terms used in the claims. It will therefore be appreciated that the embodiments described above can be modified within the scope of the claims.

What is claimed is:

1. A connector comprising:
a receiving tray defining a receiving space;
a securing tray received in the receiving space;
a circuit board configured to be coupled to the securing tray;
a plurality of pins attached to the securing tray; the plurality of pins comprises a first pin assembly located on a first plane and a second pin assembly located on a second plane, and each pin comprising a coupling terminal; and
a cable coupled to the circuit board;
wherein each coupling terminal of the first pin assembly and each coupling terminal of the second pin assembly are located on the same plane that is different from the first plane and the second plane, the coupling terminals of the plurality of pins are coupled to the circuit board, and the plurality of pins is coupled to the cable via the circuit board.

2. The connector of claim 1, wherein the second plane is substantially parallel to the first plane.

3. The connector of claim 1, wherein the first pin assembly comprises a power pin, two data pins and a first ground pin, a coupling terminal of the power pin is located on a first side, a coupling terminal of the first ground pin is located on a second side opposite to the first side, and two coupling terminals of the two data pins are located between the coupling terminal of the power pin and the coupling terminal of the first ground pin.

4. The connector of claim 3, wherein the securing tray comprises a securing portion, the connector further comprises a positioning member attached to the securing portion, and the coupling terminal of the plurality of pins are positioned by the positioning member.

5. The connector of claim 4, wherein the positioning member comprises a plurality of positioning blocks, each positioning blocks defines a through hole, and each pin of the first pin assembly extends through the through hole.

6. The connector of claim 3, wherein the second pin assembly comprises two super signal receiving pins, two super signal sending pins, and a second ground pin located between the two signal receiving pins and the two super signal sending pins, two coupling terminals of the two super signal receiving pins are located between the coupling terminal of the power pin and one coupling terminal of the second ground pin, two coupling terminals of the two super signal sending pins are located between the coupling pin of the first ground pin and the another coupling terminal of the second ground pin.

7. The connector of claim 1, further comprising a protecting member, wherein the protecting member is secured on the circuit board.

8. The connector of claim 1, wherein the receiving tray comprises two clipping pieces, and the two clipping pieces are attached to opposite sides of the circuit board.

9. A connector comprising:
a receiving tray defining a receiving space, two clipping pieces extending from the receiving tray;
a securing tray comprising a securing portion; a plurality of pins attached to the securing tray and extending from the securing portion, and each pin comprising a coupling terminal;
a circuit board, and the two clipping pieces attached to opposite sides of the circuit board; and
a cable;
wherein the coupling terminals of the plurality of pins are coupled with the circuit board, and the plurality of pins is coupled with the cable via the circuit board.

10. The connector of claim 9, wherein the plurality of pins comprises a first pin assembly located on a first plane and a second pin assembly located on a second plane, each coupling terminal of the first pin assembly and each coupling terminal of the second pin assembly are located on a same plane.

11. The connector of claim 10, wherein the second plane is substantially parallel to the first plane.

12. The connector of claim 10, wherein the first pin assembly comprises a power pin, two data pins and a first ground pin, a coupling terminal of the power pin is located on a first side, a coupling terminal of the first ground pin is located on a second side opposite to the first side, and two coupling terminals of the two data pins are located between the coupling terminal of the power pin and the coupling terminal of the first ground pin.

13. The connector of claim 12, wherein the connector further comprises a positioning member attached to the securing portion, and the coupling terminal of the plurality of pins are positioned by the positioning member.

14. The connector of claim 13, wherein the positioning member comprises a plurality of positioning blocks, each positioning blocks defines a through hole, and each pin of the first pin assembly extends through the through hole.

15. The connector of claim 12, wherein the second pin assembly comprises two super signal receiving pins, two super signal sending pins, and a second ground pin located between the two signal receiving pins and the two super signal sending pins, two coupling terminals of the two super signal receiving pins are located between the coupling terminal of the power pin and one coupling terminal of the second ground pin, two coupling terminals of the two super signal sending pins are located between the coupling pin of the first ground pin and the another coupling terminal of the second ground pin.

16. The connector of claim 9, wherein the receiving tray comprises two clipping pieces, and the two clipping pieces are attached to opposite sides of the circuit board.

17. A manufacturing method comprising:
locating a plurality of coupling terminals of a plurality of pins on a same plane;
coupling the plurality of coupling terminals of a plurality of pins with a circuit board; and
coupling the circuit board with the cable.
